(19) United States
(12) Patent Application Publication
(10) Pub. No.: US 2008/0171832 A1
(43) Pub. Date: Jul. 17, 2008

(54) Polyurethane dispersions based on 2,2'-MDI

(76) Inventors: Rolf Gertzmann, Leverkusen (DE); Rolf Roschu, Willich (DE); Hans-Ulrich Meier-Westhues, Leverkusen (DE); Christoph Irle, Dormagen (DE)

Correspondence Address: BAYER MATERIAL SCIENCE LLC, 100 BAYER ROAD, PITTSBURGH, PA, 15205, US

(21) Appl. No.: 12/008,078

(22) Filed: Jan. 8, 2008

(30) Foreign Application Priority Data
Jan. 12, 2007 (DE) 102007001868.3

(51) Int. Cl. C09D 175/04; C08G 18/02

(52) U.S. Cl. 524/839; 528/59

(57) ABSTRACT

The invention relates to aqueous polyurethane dispersions comprising diphenyl-methane 2,2′-diisocyanate as a synthesis component, to a process for preparing them and to use as coating compositions.

### CROSS-REFERENCE TO RELATED APPLICATION

This application claims priority under 35 U.S.C.§119 (a-d) to German application Serial No. 10 2007 001 868.3, filed Jan. 12, 2007.

### FIELD OF THE INVENTION

The invention relates to aqueous polyurethane dispersions comprising diphenyl-methane 2,2′-diisocyanate as a synthesis component, to a process for preparing them and to use as coating compositions.

### BACKGROUND OF THE INVENTION

Polyurethanes are particularly high-value and very universal polymers which meet particularly high requirements in terms of mechanical load-bearing capacity, such as low abrasion, for example. In the field of the coating of surfaces subject to high mechanical stress, in particular, the use of polyurethanes based on aromatic polyisocyanates is an advantage. Nevertheless, the preparation of aqueous polyurethane (PU) dispersions is possible only with highly complex apparatus, owing to the high reactivity of the aromatically attached isocyanate groups towards water. Aqueous PU dispersions comprising aromatic isocyanates as a synthesis component, moreover, exhibit limited storage stability.

EP-0 220 000 A2 discloses stable dispersions which are prepared with the proportional use of 2,4′-diphenylmethane diisocyanate to prepare prepolymers with terminal, aromatic isocyanates and subsequently are dispersed. The products prepared from these dispersions have not only an improved resistance to solvents and water but also improved physical properties in relation to pure tolylene diisocyanates. Nevertheless, dispersions described therein exhibit inadequate storage stability, which is evident in the formation of coagulum in the dispersion.

EP 0 373 671 A2 describes aqueous polyurethane dispersions synthesized from isocyanate mixtures. Suitable isocyanate mixtures are those composed entirely of aromatic polyisocyanates or of an aromatic polyisocyanate and at least one aliphatic polyisocyanate. Among the aromatic diisocyanates specified is diphenylmethane 4,4′-diisocyanate. The products disclosed therein have a high particle size, leading to unwanted formation of coagulum and hence to an inadequate storage stability.

There continues to be a need for aqueous polyurethane dispersions which produce coatings of sufficient elasticity and effective abrasion characteristics at the same time. Such dispersions ought in particular to be storage-stable, i.e. without formation of coagulum.

### SUMMARY OF THE INVENTION

The aforementioned problem has been solved in accordance with the invention by the provision of aqueous PU dispersions which comprise as a synthesis component a mixture of at least two polyisocyanates of which one polyisocyanate is diphenylmethane 2,2′-diisocyanate.

The present invention accordingly provides aqueous polyurethane (PU) dispersions comprising a mixture A) of two or more polyisocyanates as synthesis components, of which one polyisocyanate Al) is diphenylmethane 2,2′-diisocyanate.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

The mixture A) comprises at least two or more polyisocyanates An+1), with the proviso that in this mixture there is at least 5%, preferably 25% to 90%, more preferably 30% to 80%, with very particular preference 35% to 70% by weight of diphenylmethane 2,2′-diisocyanate A1) and n is integral and n+1 stands for different isocyanates.

The aqueous polyurethane dispersions of the invention comprise in addition to the synthesis component A), as further synthesis components:
B) one or more polyols having number-average molar weights of 500 to 6000 g/mol,
C) one or more isocyanate-reactive, ionically or potentially ionic compounds, and
D) one or more low molecular weight compounds of molar weight 62 to 499 g/mol, which in total possess two or more hydroxyl and/or amino groups.

Preferably the aqueous polyurethane dispersions of the invention comprise in addition to the synthesis component A), as further synthesis components:
B) one or more polyols having number-average molar weights of 500 to 6000 g/mol,
C) one or more isocyanate-reactive, ionically or potentially ionic compounds, and
D) one or more low molecular weight compounds of molar weight 62 to 499 g/mol, which in total possess two or more hydroxyl and/or amino groups and
F) hydrophilic emulsifiers.

The polyurethane dispersions of the invention may optionally comprise monoalcohols and/or monoamines E).

The polyurethane dispersion of the invention comprises as synthesis components 5% to 60%, preferably 15% to 57% and more preferably 25% to 55% by weight of components An+1), 15% to 70%, preferably 20% to 65% and more preferably 25% to 60% by weight of component B), 0.5% to 15%, preferably 2% to 14% and more preferably 3% to 12% by weight of component C), 0.5% to 20%, preferably 2% to 18% and more preferably 4% to 15% by weight of component D), and 0% to 5%, preferably 0% to 4% and more preferably 0% to 2% by weight of component E) and 0% to 8%, more preferably 0% to 6% and with particular preference 0% to 5% by weight of component F), the percentages being based on the weight of the resin solids and adding up to 100% by weight.

Preferably the polyurethane dispersion of the invention comprises as synthesis components 5% to 60%, preferably 15% to 57% and more preferably 25% to 55% by weight of components An+1), 15% to 70%, preferably 20% to 65% and more preferably 25% to 60% by weight of component B), 0.5% to 15%, preferably 2% to 14% and more preferably 3% to 12% by weight of component C), 0.5% to 20%, preferably 2% to 18% and more preferably 4% to 15% by weight of component D), and 0% to 5%, preferably 0% to 4% and more preferably 0% to 2% by weight of component E) and 0.1% to 8%, more preferably 0.5% to 6% and with particular preference 1.0% to 5% by weight of component F), the percentages being based on the weight of the resin solids and adding up to 100% by weight.

Suitable components An+1) are, besides diphenylmethane 2,2′-diisocyanate (A1), the polyisocyanates typically employed in polyurethane chemistry. Preferred diisocyanates are those of the formula R¹(NCO)₂, where R¹ stands for an aliphatic hydrocarbon radical having 4 to 12 carbon atoms, a cycloaliphatic hydrocarbon radical having 6 to 15 carbon atoms, an aromatic hydrocarbon radical having 6 to 15 carbon atoms or an araliphatic hydrocarbon radical having 7 to 15 carbon atoms. Examples of such diisocyanates are tetramethylene diisocyanate, hexamethylene diisocyanate, 1-isocyanato-3,3,5-trimethyl-5-isocyanatomethylcyclohexane (isophorone diisocyanate), 4,4′-diisocyanatodicyclohexylmethane, 1,3-phenylene diisocyanate, 3,3′-dimethyl-4,4′-biphenylene diisocyanate, 3,3′-dichloro-4,4′-biphenylene diisocyanate, 3,3′-dimethoxy-4,4′-biphenylene diisocyanate, 1,5-naphthylene diisocyanate, 4,4′-diisocyanatodiphenylmethane, 2,4′-diisocyanatodiphenylmethane, 2,4-diisocyanatotoluene, 2,6-diisocyanatotoluene or α,α,α,‘α’-tetra-methyl-m- or p-xylylene diisocyanate, and mixtures of said diisocyanates. Preferred polyisocyanates An+1) which are used together with diphenylmethane 2,2′-diisocyanate A1) are either (4,4′-diisocyanatodiphenylmethane and/or 2,4′-diisocyanatodiphenylmethane and/or 2,4′-diisocyanatotoluene and/or 2,6-diisocyanatotoluene) and also (4,4′-diisocyanatodiphenylmethane and/or 2,4′-diisocyanatodiphenylmethane and 2,4-diisocyanatotoluene and/or 2,6-diisocyanatotoluene). Particular preference is given in conjunction with 2,2′-diisocyanatodiphenylmethane as component A1) to using mixtures of the isomers (4,4′-diisocyanatodiphenylmethane or 2,4′-diisocyanatodiphenylmethane) and (2,4-diisocyanatotoluene and/or 2,6-diisocyanatotoluene) as components An+1). Very particular preference is given to a mixture of 2,2-diiso-cyanatodiphenylmethane and 2,4′-diisocyanatodiphenylmethane and 2,4-diiso-cyanatotoluene.

It is likewise possible to use, for example, trifunctional and/or higher polyfunctional isocyanates An+1) in order thereby to ensure a certain degree of branching or degree of crosslinking of the polyurethane. Isocyanates of theses kinds are obtained, for example, by reacting difunctional isocyanates with one another in such a way that a fraction of the isocyanate groups are derivatized to give isocyanurate, biuret, allophanate, uretdione or carbodiimide groups. Also suitable are the polyisocyanates, hydrophilicized by way of nonionic groups, of the kind that are typically employed as crosslinkers in aqueous 2K PU coating materials. Polyisocyanates of this kind may have high functionalities, of more than 3, for example. As higher polyfunctional isocyanates it is also possible proportionally to use higher homologues of diisocyanatodiphenylmethane, of the kind obtained in conventional manner by phosgenating aniline/formaldehyde condensates.

Also suitable as An+1) are those polyisocyanates, hydrophilicized by way of ionic groups, of the kind typically employed as crosslinkers in aqueous 2K PU coating materials. Polyisocyanates of this kind may have high functionalities, of more than 3, for example. Hydrophilicized polyisocyanates are obtainable, for example, by modification with carboxylate, sulphonate and/or polyethylene oxide groups and/or polyethylene oxide/polypropylene oxide groups. For the hydrophilicization of the polyisocyanates it is possible to react the polyisocyanates with, for example, by reaction with deficit amounts of monofunctional, hydrophilic polyether alcohols. The preparation of hydrophilicized polyisocyanates of this kind is described for example in EP-A 0 540 985. Also highly suitable are the polyisocyanates containing allophanate groups that are described in EP-A 959087, which are prepared by reacting polyisocyanates of low monomer content with polyethylene oxide polyether alcohols under allophanatization conditions. The water-dispersible polyisocyanate mixtures based on triisocyanatononane that are described in DE-A 100 078 21 are suitable as well. Likewise possible is hydrophilicization by addition of commercially customary emulsifiers.

Suitable polymeric polyols B) in the molecular weight range from 500 to 6000 g/mol, preferably from 500 to 3000 g/mol and more preferably from 650 to 2500 g/mol are the polymeric polyols that are used for preparing polyurethanes. They have an OH functionality of at least 1.8 to 5, preferably of 1.9 to 3 and more preferably of 1.9 to 2.0.

Suitable polymeric polyols B) are, for example, polyesters, polyethers, polycarbonates, polyestercarbonates, polyacetals, polyolefins, polyacrylates and polysiloxanes. Preferred are bifunctional polyesters, polyethers, polyestercarbonates and polycarbonates. Mixtures of the described polymeric polyols B) are likewise suitable. Also suitable as component B) are block copolymers of ethylene oxide and propylene oxide groups. Such block copolymers are composed of up to 50% of ethylene oxide groups and are used in an amount of 10% to 5%, preferably of 8% to 5% and more preferably of 7% to 5% by weight, measured in relation to the total amount of the polyurethane resin.

Suitable ionically or potentially ionically hydrophilicizing compounds matching the definition of component C) are, for example, mono- and dihydroxycarboxylic acids, mono- and diaminocarboxylic acids, mono- and dihydroxysulphonic acids, mono- and diaminosulphonic acids and also mono- and dihydroxyphosphonic acids or mono- and diaminophosphonic acids and their salts such as dimethylolpropionic acid, dimethylolbutyric acid, hydroxypivalic acid, N-(2-aminoethyl)-β-alanine, 2-(2-aminoethylamino)ethanesulphonic acid, ethylenediamine-propyl- or -butylsulphonic acid, 1,2- or 1,3-propylenediamine-β-ethylsulphonic acid, malic acid, citric acid, glycolic acid, lactic acid, glycine, alanine, taurine, lysine, 3,5-diaminobenzoic acid, an adduct of aliphatic diamines such as ethylenediamine (EDA) or isophoronediamine IPDA, for example, and acrylic acid (EP-A 0 916 647, Example 1) and its alkali metal salts and/or ammonium salts; the adduct of sodium bisulphite with but-2-ene-1,4-diol, polyethersulphonate, the propoxylated adduct of 2-butenediol and NaHSO₃, described for example in DE-A 2 446 440 (page 5-9, formula I-III), and also compounds which contain units which can be converted into cationic groups, amine-based units, for example, such as N-methyldiethanolamine as hydrophilic synthesis components. In addition it is possible to use cyclohexylaminopropane-sulphonic acid (CAPS) as, for example, in WO-A 01/88006 as a compound matching the definition of component C).

Preferred components C) are compounds which carry potentially ionic groups, such as N-methyldiethanolamine, hydroxypivalic acid and/or dimethylolpropionic acid and/or dimethylolbutyric acid. Particularly preferred compounds C) are OH-functional compounds which carry the potentially anionic groups, such as hydroxypivalic acid and/or dimethylolpropionic acid and/or dimethylolbutyric acid.

Likewise suitable as component C) are amino-functional compounds C2) such as diaminocarboxylic acids or diaminosulphonic acids and their salts, such as ethylenediamine-β-ethyl- or -propylsulphonic acid, 1,2- or 1,3-propylenediamine-β-ethylsulphonic acid or reaction products of (meth)acrylic acid and primary polyamines (see for example DE-A-19 750 186, p. 2, 11. 52-57) or ethylenediamine-β-ethylcarboxylate.

Particularly suitable as component D) are polyols D1) having 2 to 4 OH groups per molecule, and also amines and amino polyols D2) having 2 to 4 primary and/or secondary amino groups.

Found as components D1) are, for example, ethanediol, 1,2- and 1,3-propanediol, 1,2-, 1,3- and 1,4-butanediol, 1,5-pentanediol, 1,6-hexanediol, 1,2-cyclohexanediol, 1,4-cyclohexanediol, cyclohexane-1,4-dimethanol, 2-ethyl-2-butylpropanediol, diols containing ether oxygen, such as diethylene glycol, triethylene glycol, tetraethylene glycol, dipropylene glycol, tripropylene glycol, polyethylene, polypropylene or polybutylene glycols, trimethylolethane, trimethylolpropane, glycerol, pentaerythritol and N-alkanolamides, such as fatty acid diethanolamides as the product of reaction of diethanolamine and C₆-C₂₄ saturated or unsaturated fatty acids, for example. Preferably fatty acids are mixtures which are of fats and oils such as coconut oil, soybean oil, sunflower oil, linseed oil, peanut oil, palm oil, palm kernel oil, rapeseed oil and coconut oil, and as component D2) use is made of hydrazine, ethylenediamine, 1,4-diaminobutane, isophoronediamine, 4,4-diaminodicyclohexylmethane, ethanolamine or diethanolamine. Preferred components D1) are 1,3-propanediol, 1,4-butanediol, 1,5-pentanediol, 1,6-hexanediol, 1,4-cyclohexanediol, cyclohexane- 1,4-dimethanol, 2-ethyl-2-butylpropanediol, diethylene glycol, triethylene glycol, tetraethylene glycol, dipropylene glycol, tripropylene glycol. Preferred components D2) are hydrazine,. ethylenediamine, 1,4-diaminobutane, isophoronediamine or 4,4-diaminodicyclohexylmethane. Particularly preferred component D2) is hydrazine.

Also suitable in addition to the use of isocyanate-reactive, polyfunctional compounds is the partial termination of the polyurethane prepolymer with monofunctional alcohols or amines E). Suitable compounds E) are aliphatic monoalcohols E1) or monoamines E2) having 1 to 18 C atoms. Preference is given to ethanol, n-butanol, ethylene glycol monobutyl ether, 2-ethylhexanol, 1-octanol, 1-dodecanol, 1-hexadecanol or di-N-alkylamines. Particular preference is given to ethanol, n-butanol, ethylene glycol monobutyl ether or 2-ethylhexanol.

Likewise suitable as component E1) are mono-hydroxy-functional esters of acrylic and/or methacrylic acid. Examples of such compounds are the mono(meth)acrylates of dihydric alcohols such as ethanediol, the isomeric propanediols and butanediols, for example, or (meth)acrylates of polyhydric alcohols such as trimethylolpropane, glycerol and pentaerythritol, for example, which contain on average one free hydroxyl group. Dispersions containing unsaturated (meth)acrylates are suitable for crosslinking by high-energy radiation, preferably by UV radiation, or chemically induced free-radical polymerization through peroxides or azo compounds, optionally in the presence of further polymerizable (meth)acrylate monomers.

The polyurethane dispersions of the invention further comprise preferably emulsifiers F) which include, for example, nonionically hydrophilic compounds containing one isocyanate-reactive group per molecule. Examples of such molecules are polyoxyalkylene ethers which have been synthesized, for example, from a monoalcohol or phenols as starter molecule and from polyethylene oxide and optionally polypropylene-polyethylene oxide blocks with a number-average molar weight of 250 to approximately 3000. Given a sufficient proportion of these nonionically hydrophilic compounds it is also possible to forego the use of ionically hydrophilic compounds (D).

Preferred emulsifiers F) are anionic components which contain sulphate, sulphonate, phosphate or carboxylate groups and carry no centres reactive towards NCO groups. These include, for example, alkyl sulphates with alkyl chains of C8 to C18, ether sulphates with a nonylphenol radical, phosphate esters of an ethoxylated C8 to C18 alcohol, C8- to C18-alkyl-substituted benzylsulphonates or sulphosuccinates.

The present invention further provides a process for preparing the aqueous polyurethane dispersions of the invention, characterized in that components B), C) and D) are reacted separately and in any order or as a mixture with the initial-charge components A1) and An+1) to give an isocyanate-functional prepolymer, after which the water, with neutralizing amine added, is added to the prepolymer, or the prepolymer is added to the aqueous initial charge, and the prepolymer is transferred to the aqueous phase.

Ideally, components E2) and/or D2) with NH-group functionality are added only when the isocyanate reactivity is moderate and hence gelling of the batch does not result. A controlled reaction between isocyanates and amines is obtained when, in the manner familiar to the skilled person, the reaction is carried out in a sufficient quantity of solvent—as in the case of the acetone process, for example—or else after the dispersing step in the disperse phase.

For preparing the prepolymer containing isocyanate groups it is preferred initially to introduce component A) (A1) and An+1)) and to add the OH-functional components individually or as a mixture in portions or without interruption. Optionally a solvent or solvent mixture is employed in order to reduce the viscosity of the resin mixture and/or to attenuate the reactivity of certain isocyanate-reactive compounds. Depending on the choice of solvent it may later be distilled off again after the dispersing step.

Suitable solvents are the typical paint solvents known per se, such as acetone, 2-butanone, 4-methyl-2-pentanone, cyclohexanone, toluene, xylene, white spirit, mixtures containing primarily aromatics with relatively high degrees of substitution, of the kind on the market, for example, under the names Solvent Naphtha, Solvesso® (Deutsche Exxon, Cologne, Del.), Cypar® (Shell, Eschborn, Del.), Cyclo Sol® (Shell, Eschborn, Del.), Tolu Sol® (Shell, Eschborn, Del.), Shellsol® (Shell, Eschborn, Del.), carbonic esters, such as dimethyl carbonate, diethyl carbonate, 1,2-ethylene carbonate and 1,2-propylene carbonate, N-methylvalerolactam and N-methylcaprolactam, but also solvents such as diethylene glycol dimethyl ether, diethylene glycol ethyl and butyl ether acetate and dipropylene glycol dimethyl ether or any desired mixtures of such solvents. Preferred solvents are N-methylpyrrolidone, N-ethylpyrrolidone, dipropylene glycol dimethyl ether, acetone and methyl ethyl ketone. Particular preference is given to acetone as the solvent, which can be separated off by distillation after the dispersing step.

In a further step the groups capable of neutralization are converted into the salt form. By addition of water to the polymer resin or by addition of the polymer resin to the water, in each case with the introduction of sufficient shearing energy, a dispersion is generated, in the manner familiar to the skilled person. It is in principle, however, also possible to use hydrophilic components C), such as the components C2)—ethylenediamine-β-ethyl- or -propylsulphonate, 1,2- or 1,3-propylenediamine-β-ethylsulphonate—which are already present in salt form when added to the polyurethane prepolymer, of the kind used, for example, when preparing polyurethane dispersions by the acetone process.

Suitable neutralizing agents are alkaline organic and/or alkaline inorganic compounds. Preference, besides aqueous ammonia, ethylamine and dimethylamine solution, is given to volatile primary, secondary and tertiary amines, such as triethylamine, N-methylmorpholine, N-ethylmorpholine, N-methylpiperidine, triethanolamine, ethyldiisopropylamine and isopropyldimethylamine or mixtures of these compounds. Preference is given to isocyanate-inert tertiary amines such as, for example, triethylamine, ethyldiisopropylamine, N-methylmorpholine and N-ethylmorpholine. Mixtures of neutralizing amines are likewise suitable.

The neutralization of the polyurethane prepolymer with potentially ionic groups preferably, however, takes place only in the aqueous phase. In that case the water used for dispersing is admixed in sufficient quantity with a component capable of salt formation with the component (D) incorporated in the prepolymer. Depending on the degree of neutralization, the dispersion may be made very fine, so that it virtually has the appearance of a solution; however, very coarse formulations are possible as well, and are likewise sufficiently stable. The solids content as well can be varied, from 20% to 65% by weight, for example. A preferred solids range extends from 25% to 50% by weight. Particular preference is given to a solids content of 30% to 40% by weight.

Excess isocyanate groups are subsequently reacted by reaction with isocyanate-reactive compounds D2) and/or E2) (chain extension, chain termination). For this purpose it is preferred to use primary or secondary mono-, di- and triamines and hydrazine, which with particular preference have already been added to the water used for dispersion.

The amount of the nitrogen-containing, isocyanate-reactive component(s) D2) and/or E2) is calculated such that 30% to 105%, preferably 40% to 90% of the isocyanate groups are able to be consumed by reaction. With particular preference 30% to 50% of the isocyanate groups are reacted with hydrazine D2). Remaining isocyanate groups react with the water present.

For preparing coating compositions, the polyurethane dispersions of the invention are used either alone or in combination with other aqueous binders. Such aqueous binders may be synthesized, for example, from polyester, polyacrylate, polyepoxide or polyurethane polymers. Also possible is the combination with radiation-curable aqueous binders. A further possibility is to polymerize polymerizable, vinylically unsaturated monomers in the presence of the polyurethane dispersions of the invention, in order to obtain hybrid dispersions. For this purpose, in the presence of the polyurethane dispersion, an emulsion polymerization of olefinically unsaturated monomers such as esters and/or amides of (meth)acrylic acid and alcohols having 1 to 18 C atoms, styrene, vinyl esters or butadiene is carried out. The monomers may contain functional groups such as hydroxyl or acetoacetoxy groups and also one or more olefinic double bonds.

The present invention accordingly provides physically drying coating compositions comprising the polyurethane dispersions of the invention.

In addition it is possible, before applying the coating composition comprising the polyurethane dispersion of the invention, to add crosslinkers. Suitable for this purpose are preferably hydrophilic and hydrophobic polyisocyanate crosslinkers having free NCO groups. The present invention therefore also provides aqueous two-component (2K) coating compositions comprising polyurethane dispersions according to claim 1 and a crosslinker.

The polyurethane dispersions of the invention are preferably used as binders in coating compositions. Coatings based on the polyurethane dispersions of the invention can be applied to any desired substrates, examples being wood, metal, plastic, paper, leather, textiles, felt, glass or mineral substrates, and also to substrates that have already been coated. One particularly preferred application is the coating of wood and plastic floors and also mineral floors.

The present invention also provides for the use of the polyurethane dispersions of the invention for producing clearcoats, pigmented or non-pigmented coatings. Suitable substrates are mineral and ceramic substrates and materials, concrete, hard fibre materials, metallic substrates, plastics, paper, cardboard, composite materials, glass, porcelain, textile and/or leather. Preferred substrates are wooden and wood-like substrates such as furniture, fibreboard, wood-block flooring, window frames, doors, panels, boards or beams, for example.

The polyurethane dispersions of the invention can be used as they are or in combination with the auxiliaries and adjuvants known from paint technology, such as fillers, pigments, solvents and flow control assistants, for example, for producing coatings.

The application of the coating compositions comprising the polyurethane dispersion of the invention can take place by known techniques, such as by brushing, pouring, knifecoating, spraying, injecting, spincoating, rolling or dipping, for example. The drying of the paint film can take place at room temperature or elevated temperature, or alternatively by baking at up to 200° C.

### EXAMPLES

TABLE 1
Components employed

| Trade | | | |
|---|---|---|---|
| name | Function | Designation | Manufacturer |
| Pluronic ® | | Polyethylene glycol-block- | BASF AG, |
| PE 4300 | | polypropylene glycol-block- | Ludwigshafen, |
| | | polyethylene glycol, F* = 2, | DE |
| | | MW ≈ 1600 g/mol, 30% by | |
| | | wt. ethylene glycol fraction | |
| Simulsol ® | Emul- | Polyethoxylated lauryl alcohol | Seppic S.A., |
| P 23 | sifier | (23 ethylene oxide units), | Paris, F |
| | | HLB value = 16.9 | |
| Terathane ® | | Poly(tetramethylene oxide, | DuPont, Bad |
| 2000 | | MW 2000 | Homburg, DE |
| | | (functionality = 2), | |

F* = functionality with respect to isocyanates

PU dispersion 1

A mixture of 108.4 g of tolylene 2,4-diisocyanate, 77.9 g of 2,2′-diisocyanato-diphenylmethane and 77.9 g of 2,4′-diisocyanatodiphenylmethane was added over the course of 2 minutes to a mixture of 33.9 g of dimethylolpropionic acid, 310.3 g of a polyester of adipic acid and 1,6-hexanediol (OHN- 47 mg KOH/g) and 69.6 g of 1,6-hexanediol in 173 g of acetone. Through external cooling of the reaction mixture the temperature was initially held at about 56° C. After the exothermic reaction had subsided, the mixture was stirred at 60° C. until it attained the theoretical NCO content (2.4%). Then 3.5 g of Simulsol P 23 were added and stirred fully into the reaction mixture. 800 g of the prepolymer cooled to 25° C. were added with vigorous stirring to a solution, introduced at 15° C., of 1314 g of water, 28.9 g of triethylamine and 3.5 g of hydrazine hydrate (64% strength solution). The fine-particle dispersion formed was subsequently stirred at 40° C. for 20 minutes, after which the acetone was removed from the dispersion by distillation. After the dispersion had cooled to room temperature, it was filtered through a rapid filter (240 μm). The dispersion was still stable even after 6 months' storage at 20° C.; no sediment was observed.

### Characteristics of the Polyurethane Dispersion:

| Average particle size: | 106 nm |
|---|---|
| (laser correlation spectroscopy, LCS) | |
| pH (20° C.): | 8.6 |
| Solids content: | 34% |

PU dispersion 2

A mixture of 81.3 g of tolylene 2,4-diisocyanate, 81.8 g of 2,2′-diisocyanato-diphenylmethane and 35.1 g of 2,4′-diisocyanatodiphenylmethane was added over the course of 2 minutes to a mixture of 25.4 g of dimethylolpropionic acid, 232.7 g of a polyester of adipic acid and 1,6-hexanediol (OHN- 47 mg KOH/g), 22.5 g of Pluronic® PE 4300 and 52.2 g of 1,6-hexanediol in 129.5 g of acetone. Through external cooling of the reaction mixture the temperature was initially held at about 56° C. After the exothermic reaction had subsided, the mixture was stirred at 60° C. until it attained an NCO content of 2.2% by weight (theoretical NCO content 2.4%). Then 2.7 g of Simulsol® P 23 were added and stirred fully into the reaction mixture. 500 g of the prepolymer cooled to 25° C. were added with vigorous stirring to a solution, introduced at 15° C., of 821 g of water, 18.1 g of triethylamine and 2.2 g of hydrazine hydrate (64% strength solution). The dispersion formed was subsequently stirred at 40° C. for 20 minutes, after which the acetone was removed from the dispersion by distillation. After the dispersion had cooled to room temperature, it was filtered through a rapid filter (240 μm). The dispersion was still stable even after 4 months' storage at 20° C.; no sediment was observed.

### Characteristics of the Polyurethane Dispersion:

| Average particle size: | 275 nm |
|---|---|
| (laser correlation spectroscopy, LCS) | |
| pH (20° C.): | 8.9 |
| Solids content: | 35% |

PU dispersion 3

A mixture of 81.3 g of tolylene 2,4-diisocyanate, 35.1 g of 2,2′-diisocyanato-diphenylmethane and 81.8 g of 2,4′-diisocyanatodiphenylmethane was added over the course of 2 minutes to a mixture of 25.4 g of dimethylolpropionic acid, 232.7 g of a polyester of adipic acid and 1,6-hexanediol (OHN- 47 mg KOH/g), 22.5 g of Pluronic® PE 4300 and 52.2 g of 1,6-hexanediol in 129.5 g of acetone. Through external cooling of the reaction mixture the temperature was initially held at about 56° C. After the exothermic reaction had subsided, the mixture was stirred at 60° C. until it attained an NCO content of 2.2% by weight (theoretical NCO content 2.4%). Then 2.7 g of Simulsol® P 23 were added and stirred fully into the reaction mixture. 500 g of the prepolymer cooled to 25° C. were added with vigorous stirring to a solution, introduced at 15° C., of 821 g of water, 18.1 g of triethylamine and 2.2 g of hydrazine hydrate (64% strength solution). The dispersion formed was subsequently stirred at 40° C. for 20 minutes, after which the acetone was removed from the dispersion by distillation. The dispersion, cooled to room temperature, was filtered through a rapid filter (1000 μm).

### Characteristics of the Polyurethane Dispersion:

| Average particle size: | 286 nm |
|---|---|
| (laser correlation spectroscopy, LCS) | |
| pH (20° C.): | 8.8 |
| Solids content: | 36% |

PU dispersion 4

A mixture of 57.9 g of tolylene 2,4-diisocyanate, 83.1 g of 2,2′-diisocyanato-diphenylmethane and 83.1 g of 2,4′-diisocyanatodiphenylmethane was added over the course of 2 minutes to a mixture of 32.7 g of dimethylolpropionic acid, 144.0 g of Terathanee 2000 and 57.4 g of 1,6-hexanediol in 157.6 g of acetone. Through external cooling of the reaction mixture the temperature was initially held at about 56° C. After the exothermic reaction had subsided, the mixture was stirred at 60° C. until it attained an NCO content of 2.4% by weight (theoretical NCO content 2.7%). Then 14.6 g of hydroxyethyl methacrylate and also 47 mg of 2,6-di-tert-butyl-4-methylphenol were added and stirred at the same temperature until the NCO content was 1.7% by weight (theoretical NCO content 1.9% by weight). 500 g of the prepolymer cooled to 25° C. were added with vigorous stirring to a solution, introduced at 15° C., of 1048 g of water and 19.6 g of triethylamine. The dispersion formed was subsequently stirred at 40° C. for 20 minutes, after which the acetone was removed from the dispersion by distillation.

The dispersion, cooled to room temperature, was filtered through a rapid filter (240 μm).

### Characteristics of the Polyurethane Dispersion:

| Average particle size: | 78 nm |
|---|---|
| (laser correlation spectroscopy, LCS) | |
| pH (20° C.): | 8.2 |
| Solids content: | 27% |

Comparative Example PU dispersion 5

A mixture of 108.4 g of tolylene 2,4-diisocyanate and 155.8 g of 4,4′-diisocyanatodiphenylmethane was added over the course of 2 minutes to a mixture of 33.9 g of dimethylolpropionic acid, 310.3 g of a polyester of adipic acid and 1,6-hexanediol (OHN: 47 mg KOH/g) and 69.6 g of 1,6-hexanediol in 173 g of acetone. Through external cooling of the reaction mixture the temperature was initially held at about 56° C. After the exothermic reaction had subsided, the mixture was stirred at 60° C. until it attained the theoretical NCO content (2.4%). Then 3.5 g of Simulsol® P 23 were added and stirred fully into the reaction mixture. 800 g of the prepolymer cooled to 25° C. were added with vigorous stirring to a solution, introduced at 15° C., of 1314 g of water, 28.9 g of triethylamine and 3.5 g of hydrazine hydrate (64% strength solution). The dispersion formed was subsequently stirred at 40° C. for 20 minutes. During this subsequent stirring time the dispersion underwent sedimentation.

### Comparative Example PU Dispersion 6

A mixture of 108.4 g of tolylene 2,4-diisocyanate and 77.9 g of 4,4′-diisocyanato-diphenylmethane and 77.9 g of 2,4′-diisocyanatodiphenylmethane was added over the course of 2 minutes to a mixture of 33.9 g of dimethylolpropionic acid, 310.3 g of a polyester of adipic acid and 1,6-hexanediol (OHN- 47 mg KOH/g) and 69.6 g of 1,6-hexanediol in 173 g of acetone. Through external cooling of the reaction mixture the temperature was initially held at about 56° C. After the exothermic reaction had subsided, the mixture was stirred at 60° C. until it attained the theoretical NCO content (2.4%). Then 3.5 g of Simulsol® P 23 were added and stirred fully into the reaction mixture. 800 g of the prepolymer cooled to 25° C. were added with vigorous stirring to a solution, introduced at 15° C., of 1314 g of water, 28.9 g of triethylamine and 3.5 g of hydrazine hydrate (64% strength solution). The dispersion formed was subsequently stirred at 40° C. for 20 minutes, after which the acetone was removed from the dispersion by distillation. The dispersion, cooled to room temperature, was filtered through a rapid filter (240 μm).

After 1 week's storage at 20° C. the dispersion had a sediment.

### Characteristics of the Polyurethane Dispersion:

| Average particle size: | 301 nm |
|---|---|
| (laser correlation spectroscopy, LCS) | |
| pH (20° C.): | 8.8 |
| Solids content: | 34% |

### PERFORMANCE EXAMPLES

Film production: 100 g of the respective dispersion were mixed thoroughly with 10 g of a 1:1 mixture of water and butyl glycol and the mixture was stored at RT for 12 h. After that, films were produced on a glass plate using a doctor blade (210 μm wet film thickness). The optical qualities of the resulting films were assessed.

TABLE 2

| | | | | | Comparative |
|---|---|---|---|---|---|
| | Ex. 1 | Ex. 2 | Ex. 3 | Ex. 4 | Ex. 6 |
| Film transparency | Clear | Clear | Clear | Clear | Hazy |
| Film surface | Smooth | Smooth | Smooth | Smooth | Rough |
| Pendulum | 77″ | 72″ | 75″ | 105″ | 72″ |
| hardness after 7 d | | | | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Aqueous polyurethane (PU) dispersions comprising a mixture A) of two or more polyisocyanates as synthesis components, of which one polyisocyanate A1) is diphenylmethane 2,2′-diisocyanate.

2. Aqueous polyurethane (PU) dispersions according to claim 1, wherein the mixture A) comprises at least two or more polyisocyanates An+1), with the proviso that in this mixture there is at least 5% by weight of diphenylmethane 2,2′-diisocyanate Al) and n is integral and n+1) stands for different isocyanates.

3. Aqueous polyurethane (PU) dispersions according to claim 1, wherein the mixture A) comprises at least two or more polyisocyanates An+1), with the proviso that in this mixture there is 25% to 90% by weight of diphenylmethane 2,2′-diisocyanate A1) and n is integral and stands for different isocyanates.

4. Aqueous polyurethane (PU) dispersions according to claim 1, further comprising as synthesis components:
B) one or more polyols having number-average molar weights of 500 to 6000 g/mol,
C) one or more isocyanate-reactive, ionically or potentially ionic compounds, and
D) one or more low molecular weight compounds of molar weight 62 to 499 g/mol and having two or more hydroxyl and/or amino groups.

5. Aqueous polyurethane (PU) dispersions according to claim 4, further comprising hydrophilic emulsifiers F) as synthesis component.

6. Process for preparing the aqueous polyurethane (PU) dispersions according to claim 1, wherein components B), C) and D) are reacted separately and in any order or as a mixture with the initial-charge components Al) and An+1) to give an isocyanate-functional prepolymer, after which the water, with neutralizing amine added, is added to the prepolymer, or the prepolymer is added to the aqueous initial charge, and the prepolymer is transferred to the aqueous phase.

7. Physically drying coating compositions comprising polyurethane (PU) dispersions according to claim 1.

8. Aqueous two-component (2K) coating compositions comprising polyurethane (PU) dispersions according to claim 1 and a crosslinker.

9. Clearcoats, pigmented or non-pigmented coatings comprising the polyurethane (PU) dispersions according to claim 1.
